(19) United States
(12) Patent Application Publication
(10) Pub. No.: US 2005/0166857 A1
(43) Pub. Date: Aug. 4, 2005

(54) Animal litter

(76) Inventors: Brent Alan Deroo, Plattville, CO (US); Timothy Lee Carlson, Ault, CO (US); Michael Beryl Willits, Greeley, CO (US)

Correspondence Address: John B. Hardaway, III;NEXSEN PRUET JACOBS & POLLARD, LLC, P.O. Box 10107, Greenville, SC, 29603, US

(21) Appl. No.: 10/757,814

(22) Filed: Jan. 15, 2004

(51) Int. Cl. A01K 1/015

(52) U.S. Cl. 119/171

(57) ABSTRACT

An animal litter and method of making animal litter formulated from a mixture of cedar mill waste, pine mill waste, recycled construction wood waste and cereal hulls.

### BACKGROUND OF THE INVENTION

Litter for cats and other small animals is marketed by a relatively large number of companies. The marketed litters include clay based products and litter made from recycled paper, vegetable matter and other agricultural plant matter. Wood particles have also been proposed for litter. A litter must not only be acceptable to the pet but also to the pet owner. A commercially acceptable litter must be inexpensive, absorbent, dust free, odor free and preferably odor suppressant. A litter should be non-toxic and biodegradable.

### SUMMARY OF THE INVENTION

The animal litter is a blended mixture of 60% cedar saw mill waste, 10% clean pine sawmill waste, 10% recycled clean construction wood waste, and 20% agricultural rice hauls. The constituents are ground, weighed and blended in a mixer. The mixture is next dried in a direct-fired rotary dryer in a low oxygen atmosphere. The dried mixture is then passed over a screen having 3/16 diameter inch holes. The oversize component is routed to a hammer mill. The mixture passing through the 3/16 inch screen and the hammer mill output is routed to a pelletizer. The pellets discharged from the pelletizer are cooled and screened to remove particles that are less than ¼ inch in diameter and then packaged for marketing. The particles that are less than ¼ inch is diameter are returned to the intake of the pelletizer.

The animal litter of this invention has excellent moisture absorption, suppresses odor, is dust free, repels fleas, is not offensive to pets, is relatively inexpensive and is non-toxic to animals.

### BRIEF DESCRIPTION OF THE DRAWINGS

A method of production of the animal litter and other aspects of this invention are illustrated in accompanying drawings, in which:

FIG. 1 is a schematic illustrating a method of producing animal litter;

FIG. 2 is illustrates characteristics of cedar waste;

FIG. 3 illustrates characteristics of peat moss.

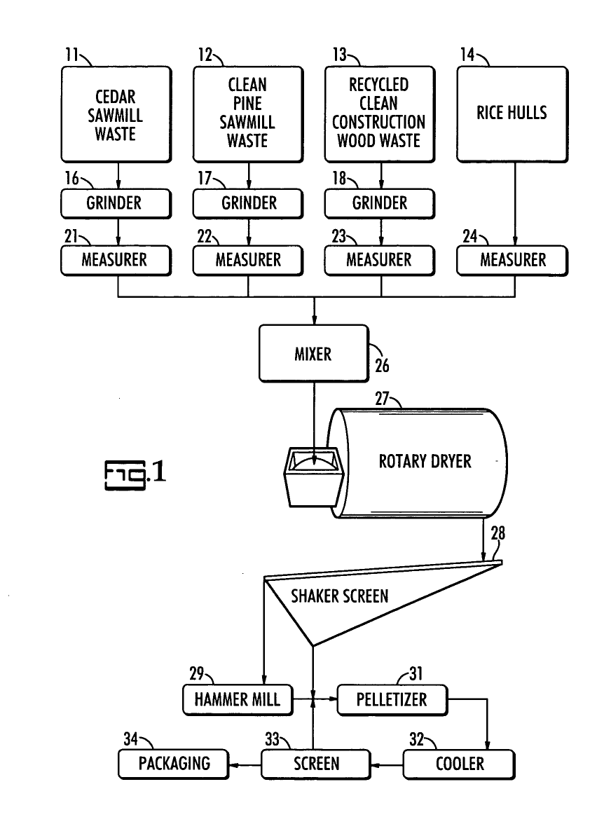

### DETAILED DESCRIPTION OF THE INVENTION

The improved animal litter of this invention is produced by processing a mixture of wood waste and cereal hulls in the manner shown in the drawing. The preferred litter composition is derived from 60% cedar wood saw mill waste 11 including recycled shavings, headrick shavings, end cuttings and cedar bark, 10% clean pine sawmill waste 12 including shavings, end cuttings and headrick dust, 10% recycled clean construction wood waste 13 and 20 percent agricultural rice hulls 14. The percentages are by preferably volume although measurement could be made by weight. The before mentioned wood constituents normally have a natural moisture content of approximately 12 to 14% by weight. The wood constituents are ground in grinders 16, 17, 18 and then measured in the measurers 21, 22, 23. The rice hulls are measured in measurers 24. The measured constituents are blended in a mixer 26 and the mixture is then delivered to a direct-fired rotary dryer 27 where the mixture is subjected to a low oxygen atmosphere and temperatures ranging from approximately 950° F. at the infeed or inlet of the dryer and approximately 240° F. at the outlet of the dryer. The dried mixture is next screened by a shaker screen 28 having 3/16 inch holes. Mixture material over 3/16 inch in diameter is passed to a hammer mill 29 for size reduction and the discharge from the hammer mill 29 is combined with the discharge from the shaker screen and the combined discharge is delivered to a pelletizer 31. The pellets are next passed through a cooler 32. The cooled pellets are next screened by a ¼ inch screen 33 which removes dust and pellet material less than ¼ inch in diameter. The litter pellets over ¼ inch in diameter are next commercially packaged at a packaging station 34 and the undersized litter material passing through the screen 33 is routed to the intake of the pelletizer 31.

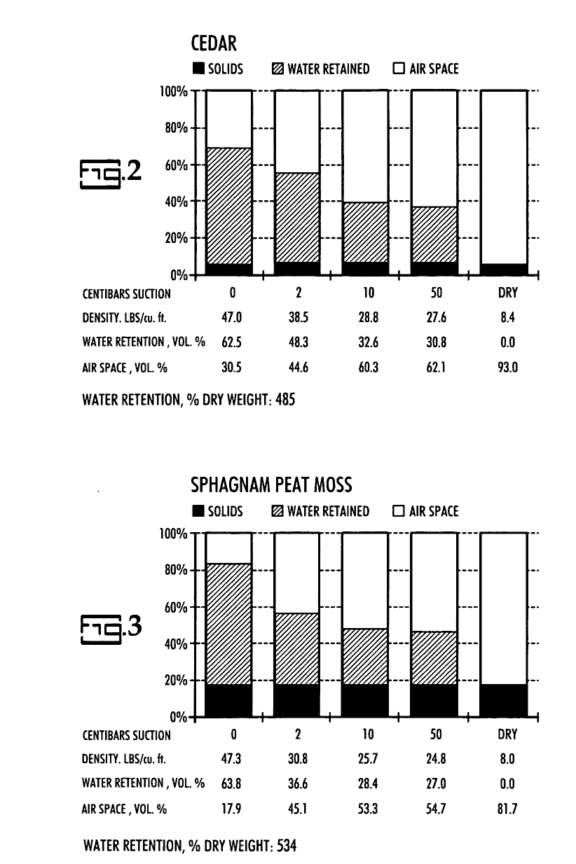

The cedar sawmill waste 11 possesses excellent moisture retention characteristics. FIGS. 2 and 3 illustrates comparative tests determining moisture retention and porosity of cedar water and sphagnum peat moss. Equal volumes of peat moss and cedar waste were tested. The density and water content of the two tested media were almost equal; however the porosity of the cedar waste was substantially greater. Thus the superior moisture retention potential of the cedar water is particularly advantageous when it, and other wood waste, is combined with other vegetable matter such as rice hulls to form animal litter. The litter pellets provide an excellent animal litter that is acceptable to animals, is non-toxic, dust free, ordor suppressive, flea repellent and reasonable in cost.

1. An animal litter comprising:
pellets made of a mixture of which cedar saw mill waste constitute 60%,
pine mill waste constitutes 10%,
recycled construction wood constitutes 10% and
cereal hulls constitute 20%, said pellets being greater than ¼ inch in diameter.

2. The animal litter of claim 1 wherein said cereal hulls are rice hulls.

3. The animal litter of claim 2 wherein said cereal hulls are rice hulls.

4. The animal litter of claim 1 wherein said animal litter has a porosity of at least 75% by volume.

5. The animal litter of claim 1 wherein said percentages are measured by volume.

6. A method of making animal litter comprising of steps of:
blending a mixture constituting 60% cedar saw mill waste, 10% clean pine saw mill waste, 10% recycled construction wood waste and 20% cereal hulls,
drying said mixture,
screening said mixture to remove oversize particles which do not pass through a first screen having 3/16 inch holes,
passing said oversize particles through a hammer mill capable of producing reduced size particles less than 3/16 inch diameter,
delivering said particles passing through said first screen and said reduced size particles discharged from said hammer mill to an intake of a pelletizer,
forming pellets in said pelletizer from particles delivered thereto and discharging pellets,
cooling said discharged pellets,
screening said pellets after said cooling in a second screen to remove undersize pellet material and passing said undersize pellet material to said intake of said pelletizer and
packing the screened pellets.

7. The method of claim 6 wherein said second screen has ¼ in diameter openings.
